(19) United States
(12) Patent Application Publication
(10) Pub. No.: US 2017/0007495 A1
(43) Pub. Date: Jan. 12, 2017

(54) THERAPEUTIC DEVICE TO ASSIST IN MYOFASCIAL RELEASE, AND METHOD OF USE

(71) Applicant: MFR PRODUCTS, INC., Louisville, CO (US)

(72) Inventors: Steve Norwood, Louisville, CO (US); Jeanne Whittle, Denver (US)

(21) Appl. No.: 15/038,730

(22) PCT Filed: Nov. 21, 2014
(86) PCT No.: PCT/US14/66947

§ 371 Date: May 23, 2016

Related U.S. Application Data
(60) Provisional application No. 61/907,282, filed on Nov. 21, 2013.
(60) Provisional application No. 61/937,308, filed on Feb. 7, 2014.

(51) Int. Cl. A61H 15/00

(52) U.S. Cl. CPC A61H 15/00; A61H 15/0092; A61H 2015/0014; A61H 2015/0035; A61H 2201/0161; A61H 2201/1261; A61H 2201/0107; A61H 2201/1671

(57) ABSTRACT

A myofascial release device includes a rigid inner core having a first density surrounded by an outer layer having a second density. The second density may be less than the first density to promote myofascial release. The rigid inner core may be a hollow aluminum core and end caps may be placed on either end of the myofascial release device. The overall diameter of the myofascial release device may be between 1.5 and 3 inches, and preferably 2 inches. The inner core may be cooled during manufacturing such that, when the inner core returns to room temperature, the diameter of the inner core is greater than or equal to the inner diameter of the outer layer.

### RELATED APPLICATIONS

This application is related to and claims the benefit of priority to each of U.S. Provisional Application Ser. No. 61/937,308, filed Feb. 7, 2014, and U.S. Provisional Application Ser. No. 61/907,282, filed Nov. 21, 2013. Each of the aforementioned applications are incorporated herein in its entirety.

### BACKGROUND

Myofascial release is a therapy technique for the treatment of muscular immobility and pain. During myofascial release therapy, a therapist locates stiff or fixed areas of the myofascia—tough membranes that wrap, connect and support the muscles—and applies pressure and/or stretching to loosen the tissues. By loosening the tissue, myofascial release therapy relieves pain and increases range of muscular movement and restores muscular balance, which in turn allows the body to return to its natural alignment.

Self-myofascial release has become popular in recent years, with a variety of products available to aid in applying pressure to tight spots. For example, foam rollers are popular devices for loosening the iliotibial band (IT Band) and other tissues at home. In using a foam roller, a user supports himself or herself on top of the roller while moving his/her body over the roller to compress the myofascia.

### SUMMARY OF THE INVENTION

While popular, conventional foam rollers do not provide adequate release for many users. It is known that when a user rolls over a tight or painful spot, that person should pause until the tissue begins to relax. Conventional advice has been to maintain pressure over the tender spot for at least 30 seconds; however, for very tight areas, it may take much longer. Pausing over a tight spot while using a conventional foam roller is known to be painful; so much so that the person using the roller may be unable to tolerate the pain long enough to facilitate release. Speeding through a rolling session does not adequately compress trigger points, and cannot provide significant myofascial release.

Those unable to tolerate hard foam rollers may instead opt for softer and more compressible models; however, soft foam rollers are often too soft to adequately pressurize the myofascia.

In addition, the large diameter of conventional foam rollers may require users to support themselves in sub-optimal positions in order to keep the body on top of the roller. For example, a user may have to arch his or her back excessively when rolling the back. In another example, a user's shoulders, elbows and/or wrists may be overly stressed when attempting to support the body while rolling the IT band, hamstrings or piriformis over a thick foam roller. Furthermore, working to keep the body in proper position on the roller is counterproductive to muscle relaxation.

What is disclosed in one embodiment is a layered foam roller for assisting in myofascial release. The roller is of varying density, with outer layers formed of a lower density material and an inner core or inner layers formed of a higher density material, thus allowing a user to bear weight on the roller for extended periods of time while still achieving adequate pressure to release the myofascia. The relatively small diameter of the varying density roller allows the user to bear weight on the device without excessive arching or other muscular work, thus allowing the user to relax on the roller and further enabling myofascial release.

In one embodiment, a varying-density myofascial roller includes a rigid cylindrical core, an inner layer of compressible material bonded about the core, and an outer layer of compressible material bonded about the inner layer. The outer layer of compressible material is less dense than the inner layer of compressible material.

### BRIEF DESCRIPTION OF THE DRAWINGS

FIG. 1 shows one exemplary embodiment of a tubular, air core Myofascial Release Device.

FIG. 2 is a cross-sectional view of the Myofascial Release Device of FIG. 1, along sectional line A-A′.

FIG. 3 shows one exemplary embodiment of a solid, cylindrical core Myofascial Release Device.

FIG. 4 is a cross sectional view of the Myofascial Release Device of FIG. 3, along line B-B′.

FIG. 5 shows one exemplary embodiment of a generic segmented Myofascial Release Device.

FIG. 6A shows one exemplary segmented Myofascial Release Device configured to fasten together via snapping attachment aspects.

FIG. 6B shows two segments of one exemplary segmented Myofascial Release Device configured to fasten together via threaded aspects.

FIG. 7 shows one exemplary segmented Myofascial Release Device configured to fasten together via a threaded rod and nut.

FIG. 8 shows one exemplary embodiment of a Myofascial Release Device having a lengthwise seam for disassembly.

FIG. 9A is a cross sectional view of the Myofascial Release Device of FIG. 8, along sectional line C-C′.

FIG. 9B is a cross sectional view of the Myofascial Release Device of FIG. 8, along sectional line C-C′ with a solid core.

FIG. 10 shows a disassembled Myofascial Release Device of FIG. 9A.

FIG. 11 shows a disassembled Myofascial Release Device of FIG. 10 in one possible cylindrical storage/travel configuration.

FIG. 12 shows a disassembled Myofascial Release Device of FIG. 9B.

FIG. 13 shows a disassembled Myofascial Release Device of FIG. 12 in one possible flat storage/travel configuration.

FIG. 14 is an elevation view of a Myofascial Release Device in an octagonal embodiment.

FIG. 15A is cross-sectional view of the Myofascial Release Device of FIG. 14, along sectional line D-D′.

FIG. 15B is cross-sectional view of the Myofascial Release Device of FIG. 15, in a solid, octagonal inner core embodiment.

FIG. 16 is a perspective view of the Myofascial Release Device of FIG. 14.

FIG. 17 is a perspective view of the Myofascial Release Device of FIG. 16 with each layer exposed.

FIG. 18 is an elevation view of a Myofascial Release Device in an octagonal, solid core embodiment.

FIG. 19 is cross-sectional view of the Myofascial Release Device of FIG. 18, along sectional line D-D′.

FIG. 20 is a perspective view of the Myofascial Release Device of FIG. 18.

FIG. 21 is a perspective view of the Myofascial Release Device of FIG. 20 with each layer exposed.

FIG. 22 is an elevation view of a Myofascial Release Device in an octagonal embodiment.

FIG. 23 is cross-sectional view of the Myofascial Release Device of FIG. 22, along sectional line D-D′.

FIG. 24 is a perspective view of the Myofascial Release Device of FIG. 22.

FIG. 25 is a perspective view of the Myofascial Release Device of FIG. 24 with each layer exposed.

FIG. 26 depicts an exemplary method for manufacturing a myofascial release device, in one embodiment.

### DETAILED DESCRIPTION OF THE DRAWINGS

The present disclosure details a therapeutic device for myofascial release. The myofascial release device described herein differs from traditional devices, known generally as foam rollers, in a number of different ways. One example of the myofacial release device includes a hollow aluminum core surrounded by a layer of foam. The hollow aluminum core has a greater density than the outer layer of foam. In another example, the myofascial release device may alternatively be configured with layers of varying density, for example, one or more outer layers formed of a lower density material than the one or more inner layers. In addition, the myofascial release device has a smaller diameter than conventional rollers, allowing a user to relax on the roller with their full body weight rather than tensing to hold themselves up in position on a larger roller. The present myofascial release device may also be customizable in the density of its layers, its diameter and its length. In one aspect, it may also be fabricated such that it may be disassembled and placed in a travel configuration, for example, a cylindrical travel mode or a flat travel mode.

Having outer layers formed of lower density material that the inner layers decreases the level of discomfort to the user such that the user may bear their weight on the myofascial release device for a extended period of time as compared to prior art foam rollers. Extending the period of time a user can use the myofascial release device facilitates a more comfortable release of the fascia surrounding the muscle tissue as compared to prior art foam rollers. Due to the extended period of time a user may apply pressure to the fascia, the present myofascial release device better releases the fascia as compared to the prior art foam rollers.

An additional benefit to the present myofascial release device is that it may be formed with a smaller diameter than prior art foam rollers while maintaining the same or better results. A smaller diameter beneficially allows a user to rest his or her back upon the roller without being forced to arch over the roller in uncomfortable, awkward, or, for people with limited mobility, impossible positions. The smaller diameter also reduces or eliminates shoulder strain that may be caused by holding oneself in place, and without exerting too much painful pressure, upon a conventional roller. In certain embodiments, the diameter of the myofascial release device is between 1.5 to 3 inches in diameter, and preferably approximately 2 inches.

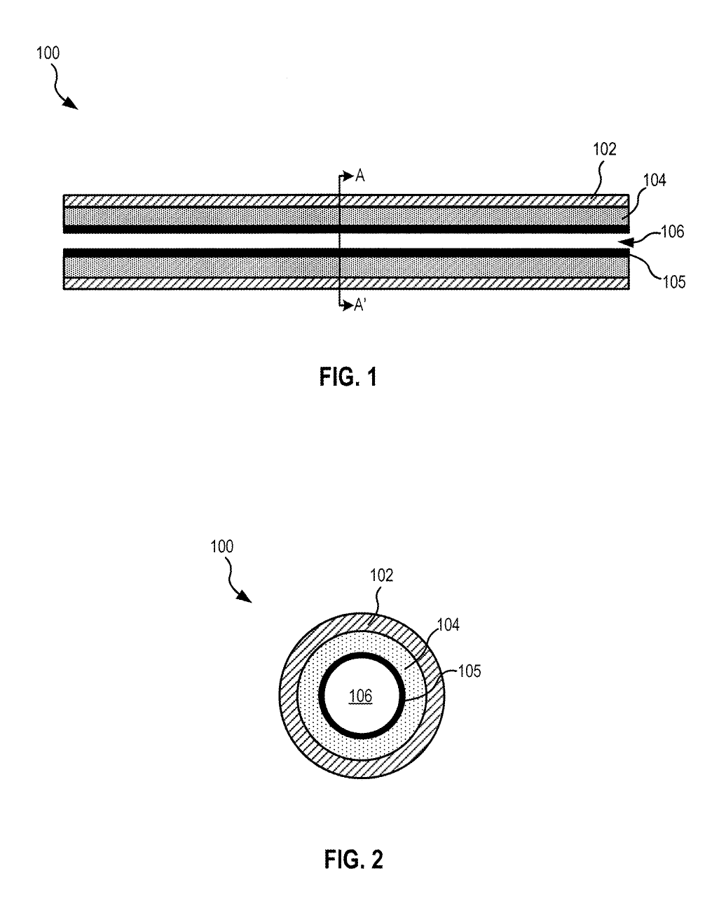

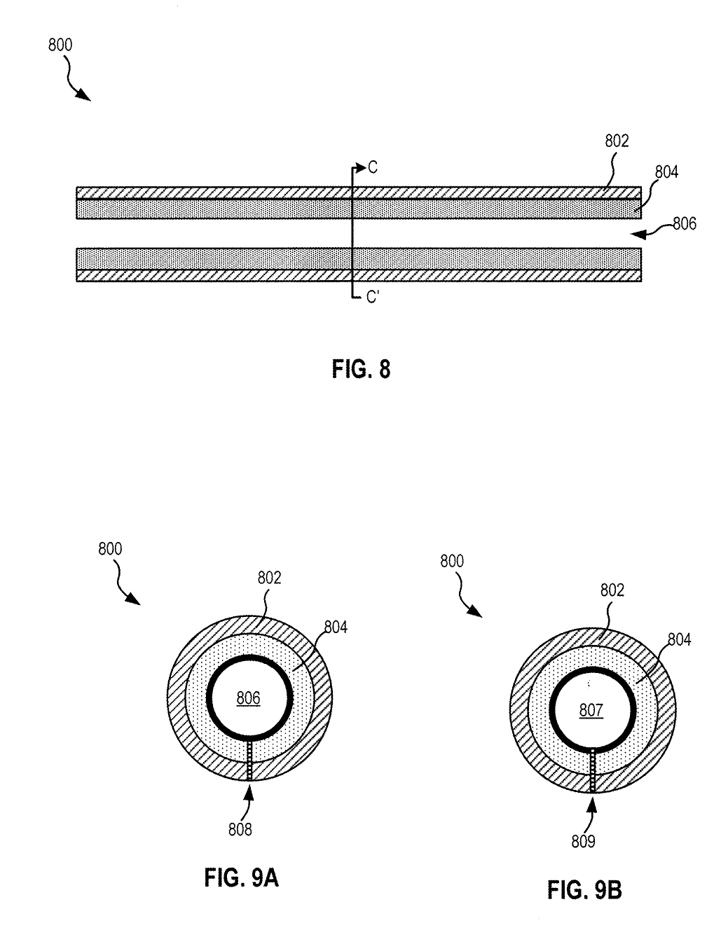

FIGS. 1-7 show myofascial release devices formed with layers that are bonded one to another, thereby forming a single unit. Bonding is for example done using traditional bonding techniques. In one aspect, the myofascial release device includes a solid core of metal, plastic or another sufficiently rigid and non-deforming material, with varying density foams bonded to the roller; denser foam being bonded directly to the core, and less dense foam encircling the denser foam. FIGS. 8-13 show myofascial release devices with unbonded layers.

FIG. 1 shows one embodiment of a Myofascial Release Device (MRD) 100. FIG. 2 shows a cross sectional view along sectional line A-A′, of FIG. 1. FIGS. 1 and 2 are best viewed together with the following description.

Myofascial Release Device 100 is formed of three layers; a cylindrical outer layer 102 of a first density, a cylindrical inner layer 104 of a second and greater density, and a substantially ridged inner core 105. Layers 102 and 104 are for example bonded to the core and to each other. Layers 102 and 104 may be foam, rubber, elastomeric material, gel- or fluid-encapsulating layers, air-filled layers, or combinations thereof.

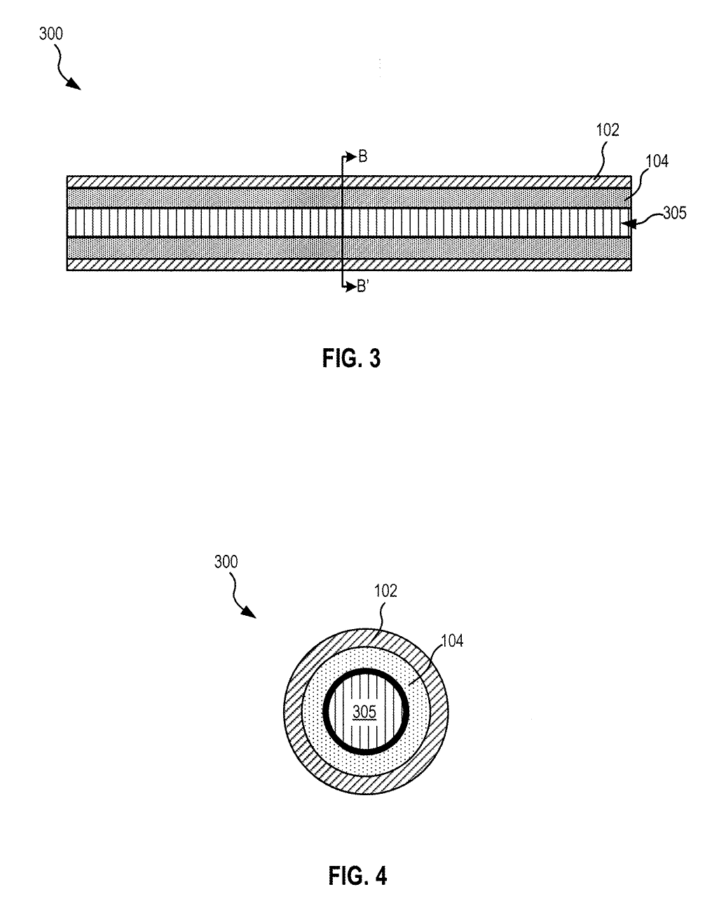

Core 105 provides structural support to cylindrical inner and outer layers 104, 102. Core 105 is shown with an internal cylindrical space 106, although the core may also be formed as a solid cylinder, for example, as shown in MRD 300, FIGS. 3, 4 (see solid core 305). The more compressible/softer nature of outer layer 102 cushions against the harder/less compressible inner layer 104 and rigid core 105, allowing a user to rest comfortably on the device while still applying pressure to a tight spot in the fascia (and/or muscle). The small diameter of MRD 100/300 (MRD 100/300 may have a diameter between 1.5 to three inches, and preferably approximately 2 inches) further enhances comfort during use by reducing or eliminating the need for a user to hold his/her body up atop the roller. Rather, the user may relax atop the roller with their full body weight and allow the ground to support his or her body without contorting or twisting to reach the ground. FIG. 4 shows a cross sectional view along section line B-B′ of FIG. 3. MRD 300 differs from MRD 100 in that solid core 305 replaces hollow core 105. It should be appreciated herein that, unless expressly described to the contrary, a solid core may be a hollow core and vice versa.

Depending on the particular use, core 105, 305 may be fabricated from one or more of a plurality of materials, including but not limited to aluminum, steel, plastic, rubber, or other rigid or semi-ridged structural material. In an alternative embodiment (not shown), the substantially ridged core may be formed as a sealable, collapsible container device that may be filled with a substantially incompressible material, such as water or pressurized air. In one embodiment, pressurized air is applied by blowing air into the containing device via a valve. In a separate embodiment, pressurized air is applied by coupling a pump to the containing device via a valve, such as a Schrader valve, although any pump/valve combination may be used without departing from the scope herein.

In one embodiment, myofascial release device 100/300 varies from about from 18″ long to 48″ long; however, device 100/300 may be manufactured in longer or shorter lengths, for example to provide a travel-friendly roller.

The myofascial release device may be customized, e.g., fabricated with more or fewer layers. Layer-customizing the myofascial release device may allow for treatment of specific body parts, body types, and individual preferences. In one embodiment (not shown), the myofascial release device is former of a single outer layer and a substantially ridged core. Again, the substantially rigid core may be solid or hollow. Alternately, the myofascial release device may be formed of a substantially ridged core and three, four, five or more layers of varying density material (for example, materials having at least two different densities).

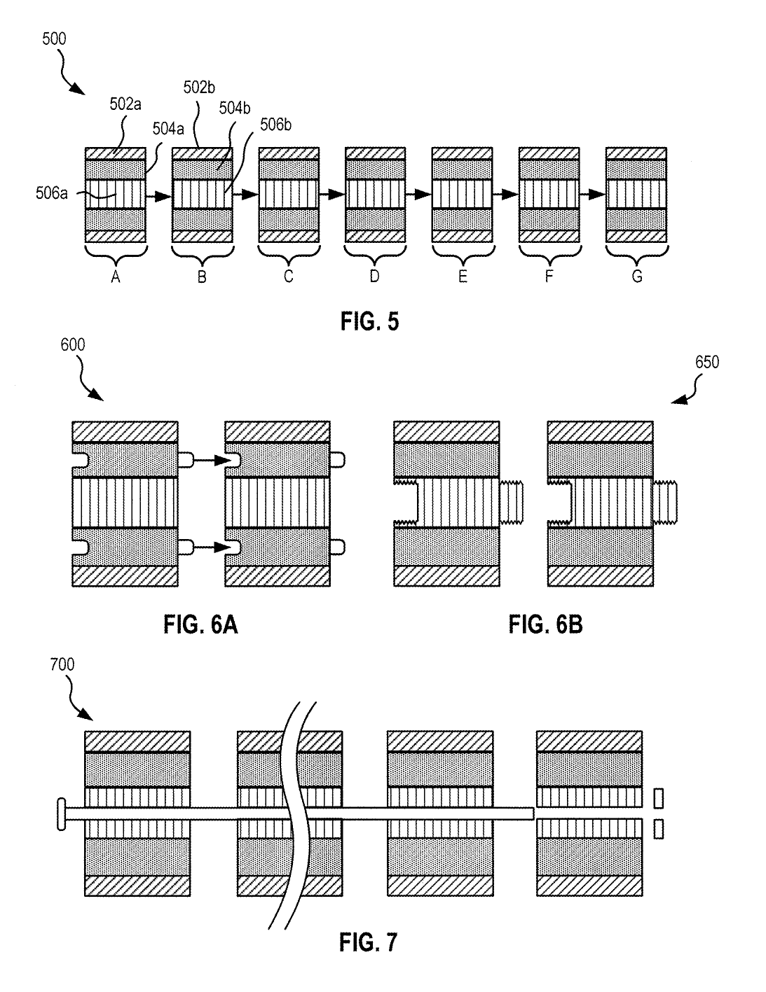

FIGS. 5-7 show MRDs 500, 600, 650 and 700, featuring lengthwise segmentation. FIG. 5 shows segments A-G. The length of MRD 500 may be customized by a user, by adding or removing one or more segments. For example, a user may decrease the length of MRD 500 by removing segments to improve the packability of MRD 500. It will also be appreciated that MRD 500 may be taken apart to facilitate packing the device in a suitcase, duffel bag or other container. Additionally, MRD 500 may be formed of segments of differing effective densities. That is, segment A may have a lower effective density than segment B, and so forth. The increase in the effective density from segment A to segment B may be stepped or gradual. A stepped density here means the density across the length of each segment is uniform. A gradual increase in effective density here means density of the left edge of segment A differs from that of its right edge. In addition, the right edge of segment A may have the same effective density as the left edge of segment B, such that it is possible to gradually change the effective density lengthwise across MRD 500, for example, from its left edge to its left edge.

FIG. 6A shows a snap attachment mechanism for securing segments together. FIG. 6B shows a screw/threaded attachment mechanism for securing segments together.

FIG. 7 shows one exemplary segmented Myofascial Release Device configured to fasten together via a threaded rod and nut.

FIGS. 8-9B illustrates a lengthwise seam running through some or all layers of an MRD, which facilitates unrolling the MRD for travel or storage.

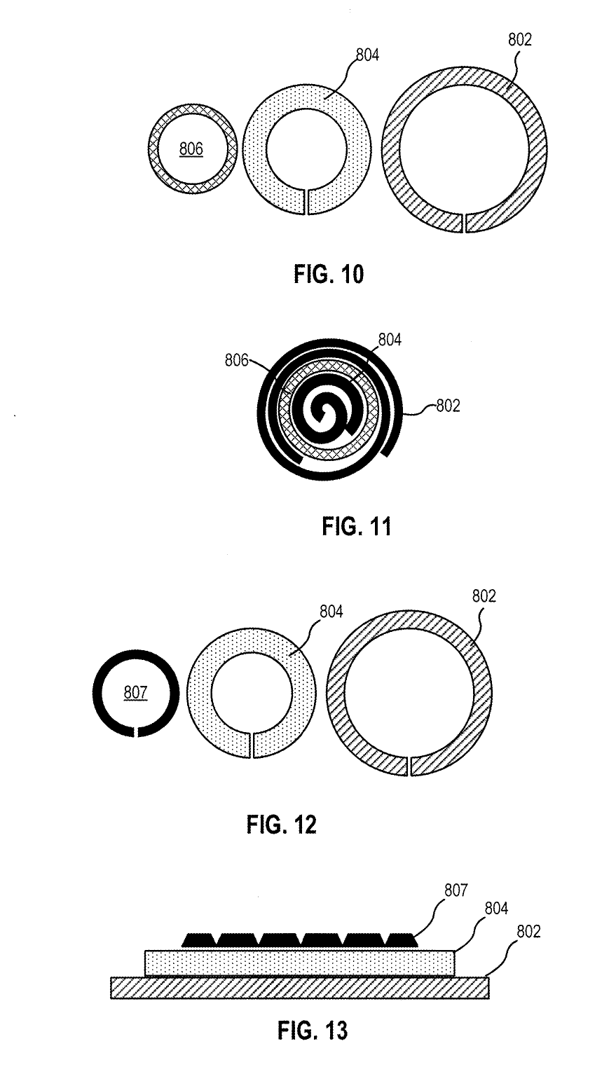

FIG. 10 shows separate layers of MRD 800, the middle layer 804 and outermost layer 802 including a seam.

FIG. 11 schematically illustrates storage of one layer of the MRD within the hollow core, and storage of the other MRD layer about the core. It will be appreciated that optionally both outermost layers of FIGS. 8-10 may be stored within the hollow core.

FIGS. 12 and 13 illustrate an MRD that may be opened along seams in its layers, and laid flat. As especially shown in FIG. 13, the core 807 may include a series of inner cut-outs that lend flexibility to the core material when it is laid flat, while closing together when the core is rolled shut, thus providing stability to the closed core.

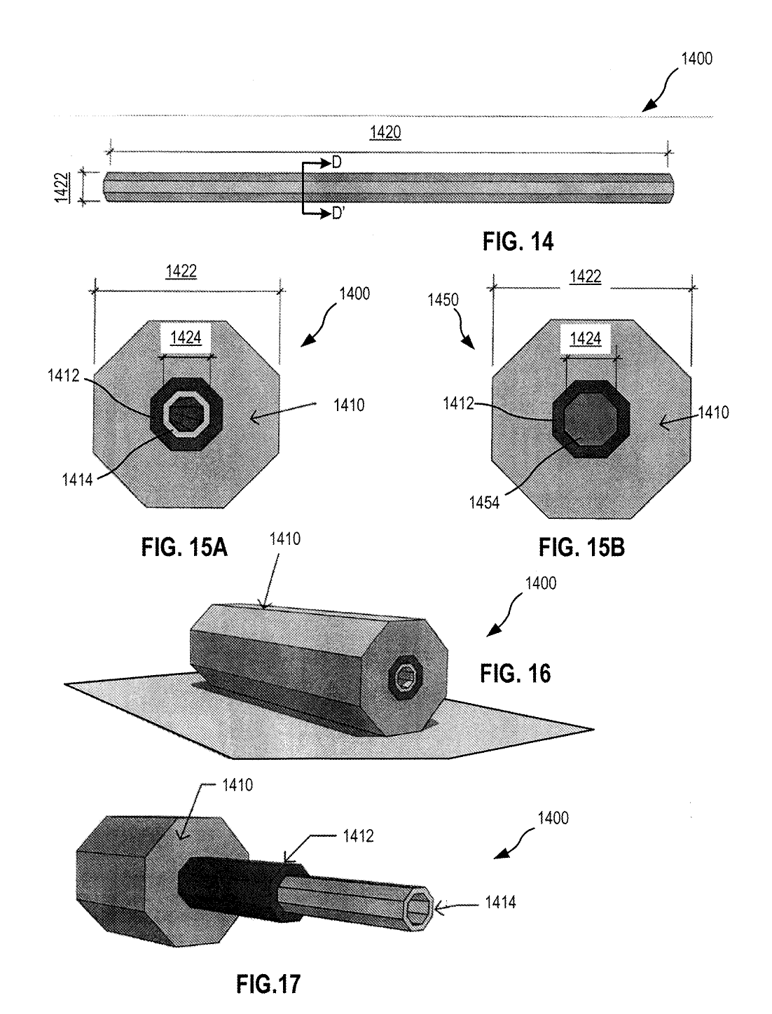

FIGS. 14-21 show exemplary Myofascial Release Devices in non-rolling embodiments. The embodiments shown in FIGS. 14-21 are octagonal embodiments that advantageously inhibit rolling of the Myofascial Release Devices when in use. It will be understood that other shapes that inhibit rolling may be used without departing from the scope herein. By inhibiting rolling when in use, the Myofascial Release Device applies constant pressure to a location on a user. Pressure is first applied to the user by the Myofascial Release Device's softer outer layer, then by the Myofascial Release Device firmer inner layer(s). The softer, outer layer relaxes and prepares the myofascial tissue for tension release, while the inner, firmer layer finalizes the tension releasing process.

FIG. 14 is an elevation view of an exemplary Myofascial Release Device 1400 in the octagonal embodiment. Device 1400 has a length 1420 and a width 1422. In an embodiment, length 1420 is 36 inches and width 1422 is 2 inches. FIG. 15A is cross-sectional view of the Myofascial Release Device 1400 of FIG. 14, along sectional line D-D′. FIG. 16 is a perspective view of the Myofascial Release Device 1400. FIG. 17 is a perspective view of the Myofascial Release Device 1400 with each layer, layers 1410, 1412, and octagonal, hollow inner core 1414, exposed for clarity of understanding. FIG. 15B is cross-sectional view of a Myofascial Release Device similar to Myofascial Release Device 1400 of FIG. 15A, but with hollow inner core 1414 replaced with an octagonal, solid inner core 1454. FIGS. 14-17 are best viewed together with the following description.

Device 1400 is shown constructed of three separate layers of material: an octagonal outer layer 1410 of a first density, an octagonal inner layer 1412 of a second and greater density, and a substantially ridged, octagonal inner core 1414. It will be understood that more layers may be used without departing from the scope herein. Outer layer 1410 has outer width 1422, for example between 1.5 and 3 inches, and preferably approximately 2″, and formed of, by way of example, a foam, rubber, or EVA material. Octagonal inner layer 1412 may be formed of a layer of, by way of example, ⅛^{th} inch thick foam, rubber or similar material, which surrounds inner core 1414. Inner core 1414 has an outer width 1424, for example ½″ and a wall thickness of 1/16^{th} inch. Inner core 1414 may be formed of, by way of example, aluminum, PVC, or other similar material.

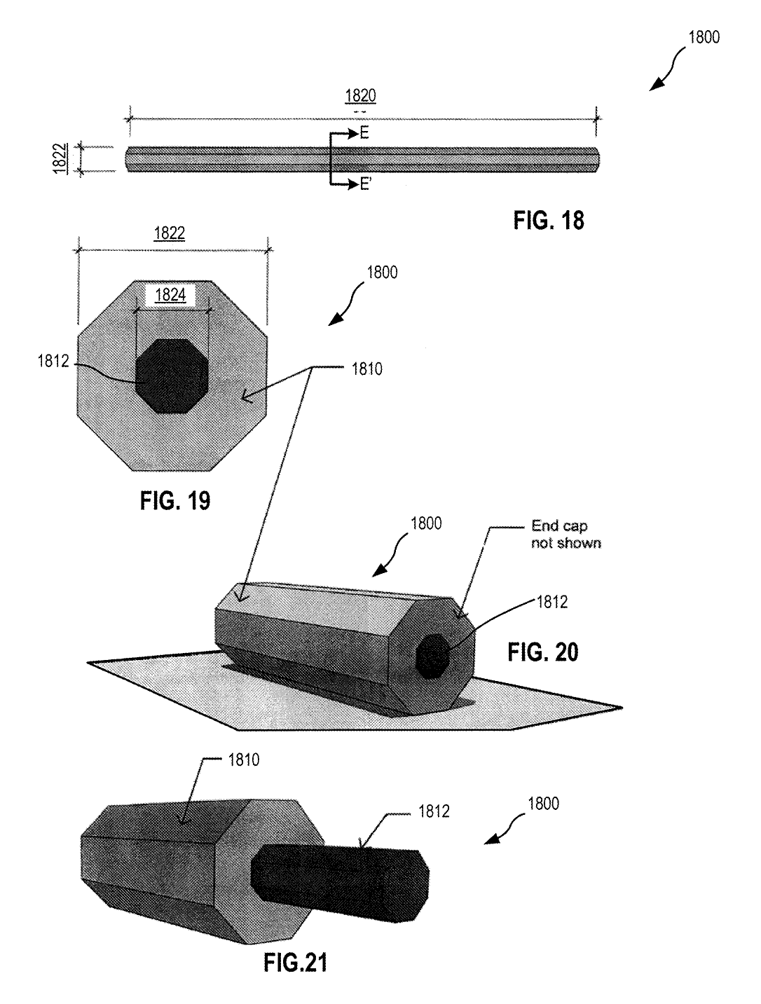

FIG. 18 is an elevation view of an exemplary Myofascial Release Device 1800 in the octagonal, solid inner layer embodiment. Device 1800 differs from device 1400 in that device 1800 does not include separate rigid, octagonal inner core 1414. Instead device 1800 is formed of two layers, an octagonal outer layer 1810, and a solid, octagonal inner layer 1812, discussed in more detail below. It should be appreciated that although octagonal inner layer 1812 is discussed herein as being a solid inner layer, the layer may be also be hollow. Device 1800 has a length 1820 and a width 1822. In an embodiment, length 1820 is 36 inches and width 1822 is between 1.5 and 3 inches, and preferably 2 inches. FIG. 19 is cross-sectional view of the Myofascial Release Device 1800 of FIG. 18, along sectional line E-E′. FIG. 20 is a perspective view of the Myofascial Release Device 1800. FIG. 21 is a perspective view of the Myofascial Release Device 1800 with each layer, layers 1810, 1812, exposed for clarity of understanding. FIGS. 18-21 are best viewed together with the following description.

Device 1800 is shown constructed of two separate layers of material: octagonal outer layer 1810 of a first density, and solid, octagonal inner layer 1812 of a second and greater density. It will be understood that more layers may be used without departing from the scope herein. Outer layer 1810 has outer width 1822, for example 2″, and formed of, by way of example, a foam, rubber, or EVA material. Octagonal inner layer 1812 may be fowled of a layer of, by way of example, ½^{th} inch thick foam, rubber or similar material.

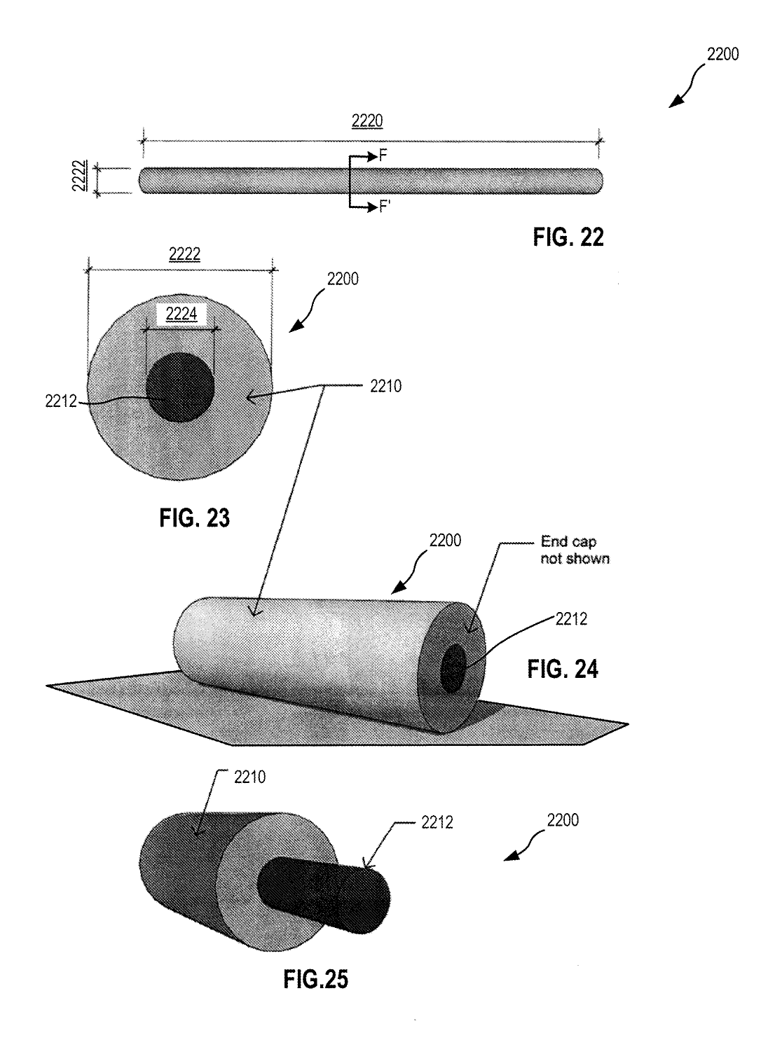

FIG. 22 is an elevation view of an exemplary Myofascial Release Device 2200 in a solid inner layer, round embodiment. Device 2200 has a length 2220 and a width 2222. In an embodiment, length 2220 is 36 inches and width 2222 is 2 inches. FIG. 23 is cross-sectional view of the Myofascial Release Device 2200 of FIG. 22, along sectional line F-F′. FIG. 24 is a perspective view of the Myofascial Release Device 2200. FIG. 25 is a perspective view of the Myofascial Release Device 2200 with each layer, layers 2210, 2212, exposed for clarity of understanding. FIGS. 22-25 are best viewed together with the following description.

Device 2200 is shown constructed of two separate layers of material: a round outer layer 2210 of a first density, and a round inner layer 2212 of a second and greater density. It will be understood that more layers may be used without departing from the scope herein. Outer layer 2210 has outer width 2222, for example between 1.5 and 3 inches, and preferably approximately 2 inches, and formed of, by way of example, a foam, rubber, or EVA material. Round inner layer 2212 may be formed of a layer of, by way of example, a hollow or solid aluminum rod. In other examples, round inner layer 2212 is formed from ¾ of an inch thick foam, rubber or similar material. The diameter of inner layer 2212 is at least equivalent to an inner diameter 2224 of outer layer 2210 such that when the outer layer is manufactured to surround the inner layer, the contacting surfaces of the outer and inner layers have sufficient friction to maintain the position of the outer layer on the inner layer. This provides the significant advantage that when manufactured (for example according to method 2600, described below) glue is not necessary. This significantly reduces manufacturing costs and time.

In an embodiment (not shown) Myofascial Release Device 1400, 1800, 2200 may include end caps at each end for sealing an internal space within a hollow, substantially ridged, core in the case of device 100, 800, 1400, and for creating a clean look to the device.

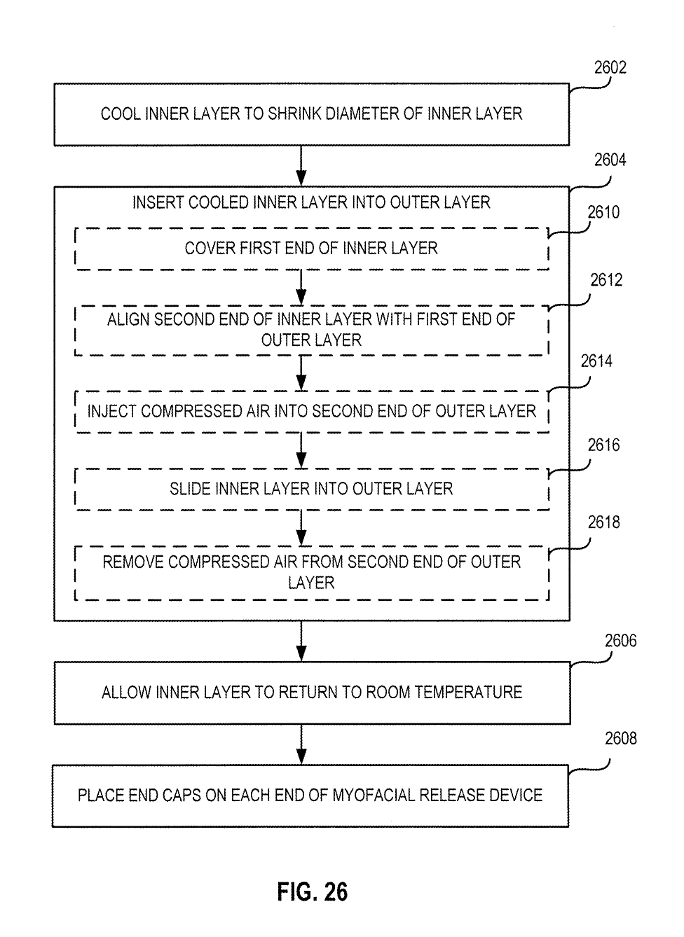

FIG. 26 depicts an exemplary method 2600 for manufacturing a myofascial release device, in one embodiment. Method 2600 is described in detail for manufacturing myofascial release device 2200, having a round outer layer 2210 and a round inner layer 2212, where the round inner layer 2212 is a hollow aluminum rod. However, it should be appreciated that the method of manufacturing may apply equally to other embodiments as well, such as embodiments where the inner rod is octagonal (FIGS. 14-21) or solid (e.g. FIGS. 3-4, and/or 18-21).

In step 2602, method 2600 shrinks a rigid inner layer by cooling the layer. In one example of operation step 2602, an aluminum inner layer 2212 is cooled to slightly shrink the diameter of the aluminum layer. For example, the layer 2212 may be cooled below 32 degrees Fahrenheit such that the diameter is less than a room temperature diameter. Step 2602 applies to both hollow and solid inner cores of any shape.

In step 2604, method 2600 inserts cooled rigid inner layer into outer layer. In one example of operation of step 2604, aluminum inner layer 2212, which was cooled in step 2602, is inserted into outer layer 2210. For example, a first end of aluminum inner layer 2212 is covered (particularly when the layer 2212 is hollow) (step 2610). A second end of aluminum inner layer 2212 is then aligned with a first end of the outer layer 2210 (step 2612). Compressed air is then injected into a second end of the outer layer 2210 (opposite the first end) (step 2614). In turn, the aluminum inner layer 2212 is then slid into the outer layer 2210 (step 2616). The compressed air acts to inflate the hollow area of outer layer 2210 such that the diameter of inner layer 2210 is less than an inner diameter 2224 of the inflated outer layer 2210. Once the compressed air is removed (step 2618), the inner diameter 2224 reduces such that inner diameter 2224 is equal to or less than the diameter of inner layer 2212.

In step 2606, method 2600 allows inner layer to heat up to room temperature. For example, as aluminum inner layer 2212 heats towards room temperature, the diameter of inner layer 2212 expands such that the diameter is greater than or equal to inner diameter 2224 of outer layer 2210. Accordingly, friction is applied between contacting surfaces of outer layer 2210 and inner layer 2212. This provides the significant advantage that glue or bonding material is not required to keep outer layer 2210 on inner layer 2212, thereby significantly reducing manufacturing costs and time. Not requiring glue also provides a significant advantage of reducing allergic reactions for users with allergies to certain adhesives. Moreover, use of method 2600 also provides for an outer layer (e.g. outer layer 2210) that does not have a seam. This in turn extends the life of the product as well as the potential areas for use of the product.

In step 2608, end caps are placed on each end of the myofacial release device. For example, end caps may be placed inside the hollow portion of aluminum inner layer 2212 to prevent ingress of dirt and other elements from entering into the hollow portion of inner layer 2212.

The devices discussed herein provide the ability for myofacial release. For example, the diameters discussed (e.g. between 1.5 inches and 3 inches, preferably 2 inches) allows for self-massaging and myofacial release. Particularly, the diameters discussed allow a user to apply pressure to a painful area using their full body weight without the user having to partially support their body as is required using previous massage rollers having thicker diameters or constant density. In turn, the user can relax on or into the bar allowing the myofascial release to occur. The small diameter allows the user to maintain position on the bar for an extended period giving the user time for the myofascial release to occur. Additionally, the diameter allows the device to be used on body parts that other devices having larger diameters cannot effectively reach such as calves, neck, feet, shoulder, etc. Moreover, the varying density (i.e. a softer outer layer with a rigid inner layer) allows for a user to tolerate this extended time on the device, thereby promoting full myofascial release.

Combination of Features:

Features described above as well as those claimed below may be combined in various ways without departing from the scope hereof. The following examples illustrate some possible combinations:

(A1) A myofacial release device including a rigid inner core having a first density and an outer layer having a second density that is less than the first density.

(A2) The device of (A1), further including end caps at each end of the myofacial release device.

(A3) Either of the devices of (A1) or (A2), the outer diameter of the myofacial release device being between 1.5 to 3 inches, and preferably 2 inches.

(A4) Any of the devices of (A1) through (A3), the inner core being solid.

(A5) Any of the devices of (A1) through (A3), the inner core being hollow.

(A6) Any of the devices of (A1) through (A5), the inner core being octagonal.

(A7) Any of the devices of (A1) through (A5), the inner core being cylindrical.

(A8) Any of the devices of (A1) through (A7), the inner core having a diameter that is greater than or equal to an inner diameter of the outer layer.

(A9) Any of the devices of (A1) through (A8), the inner core being formed of aluminum, steel, plastic, rubber, or other rigid or semi-ridged structural material.

(A10) Any of the devices of (A1) through (A9), the myofacial release device capable of being opened along seams in its layers, and laid flat; the inner core including a series of inner cut-outs that lend flexibility to the core material when it is laid flat while closing together when the core is rolled shut.

(A11) Any of the devices of (A1) through (A9), the outer layer including a seam such that the outer layer may be stored within the inner core.

(A12) Any of the devices of (A1) through (A9), the myofacial release device being segmented in a lengthwise direction.

(A13) Any of the devices of (A12), each segment having a different density; wherein the density of each segment is gradual or stepped.

(A14) Any of the devices of (A12), the right edge of one segment having the same density of the left edge of another segment.

(A15) Any of the devices of (A12) through (A14), the segments snapping together.

(A16) Any of the devices of (A12) through (A14), the segments attaching together with a threaded rod and nut.

(A17) Any of the devices of (A1) through (A16), further including one or more additional outer layers.

(A18) Any of the devices of (A1) through (A17), the inner core being a collapsible device such that the device may be filled with pressurized air, water, or other substantially incompressible material.

(A19) Any of the devices of (A1) through (A18), the inner core being bonded to the outer layer.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

We claim:

1. A myofascial roller device, comprising:
a rigid inner layer having a first density; and
an outer layer of compressible material, surrounding the inner layer, having a second density that is less than the first density;
wherein a diameter of the rigid inner layer is greater than or equal to an inner diameter of the outer layer.

2. The device of claim 1, wherein the diameter of the rigid inner layer is greater than the inner diameter of the outer layer such that, when the outer layer surrounds the inner layer, friction between contacting surfaces of the outer layer and inner layer causes the outer layer to remain secured on the inner layer.

3. The device of claim 1, the rigid inner layer comprising a hollow cylindrical core.

4. The device of claim 2, the outer layer constructed with a material selected from the group consisting of rubber, foam rubber, open cell foam, closed cell foam, filled closed cell foam and open cell polyethylene foam.

5. The device of claim 1, wherein an outer diameter of the myofascial roller device is between 1.5 and 3 inches.

6. The device of claim 1,wherein an outer diameter of the myofascial roller device is approximately 2 inches.

7. The device of claim 1, further comprising end caps on each of a first and second end of the myofascial release device.

8. A method of manufacturing a myofascial roller device, comprising:
cooling a rigid inner layer to reduce the outer diameter of the inner layer;
inserting the cooled rigid inner layer into outer layer; and,
allowing inner layer to return to room temperature such that the outer diameter of the inner layer is greater than or equal to an inner diameter of the outer layer.

9. The method of manufacturing of claim 8, the step of cooling comprising cooling a hollow aluminum inner layer below 32 degrees Fahrenheit.

10. The method of manufacturing of claim 8, the step of inserting the cooled rigid inner layer comprising:
aligning a second end of the inner layer with a first end of the outer layer;
injecting compressed air into the second end of the outer layer;
sliding inner layer into the outer layer; and
removing compressed air from second end of the outer layer.

11. The method of manufacturing of claim 9, the rigid inner layer comprising a hollow inner layer; and the step of inserting the cooled inner layer further comprising covering a first end of the inner layer prior to the step of injecting compressed air.

12. The method of manufacturing of claim 8, further comprising inserting end caps onto each end of the myofacial release device.
